(19) United States
(12) Patent Application Publication
(10) Pub. No.: US 2026/0123640 A1
(43) Pub. Date: May 7, 2026

(54) METHOD AND SYSTEM FOR STABILIZING EMULSIONS USING VITAMINS AND VITAMINS SALTS

(71) Applicant: Abstrax Tech Inc., Tustin, CA (US)

(72) Inventors: Marcos A. Ojeda, Tustin, CA (US); Marlene A. McGorrin, Tustin, CA (US); Iain W.H. Oswald, Tustin, CA (US); Thomas J. Martin, Jr., Tustin, CA (US); Kevin A. Koby, Tustin, CA (US)

(21) Appl. No.: 19/380,856

(22) Filed: Nov. 5, 2025

Related U.S. Application Data
(60) Provisional application No. 63/717,241, filed on Nov. 6, 2024.

(51) Int. Cl. A23B 2/771; A23B 70/10; A23L 27/10; A23L 29/00; A23L 29/10; C12H 1/14

(52) U.S. Cl. CPC A23B 2/771; A23B 70/10; A23L 27/10; A23L 29/035; A23L 29/10; C12H 1/14

(57) ABSTRACT

Compositions in the form of an oil-in-water emulsion composition include an oil phase that includes a flavorant; and a continuous aqueous phase that includes water, a preservative, and an emulsifying agent, and optionally an emulsifier adjuvant; wherein the preservative includes one or more vitamins and/or salts thereof.

### CROSS REFERENCE TO RELATED APPLICATIONS

This application claims the benefit of U.S. Provisional Application No. 63/717,241, filed Nov. 6, 2024, the disclosure of which is incorporated herein by reference in its entirety.

### FIELD

The present invention generally relates to compositions and methods for preserving consumer products. In particular, the present invention relates to various compositions, products, and methods involving oil-in-water emulsions that provide improved preservation of foods, and beverages.

### BACKGROUND

The following discussion is provided to aid the reader in understanding the disclosure and is not admitted to describe or constitute prior art thereto.

Emulsifiers, hydrocolloids, and other stabilizers play particularly important roles in the manufacture and stability of beverages. These components are used to prevent separation, enhance flavor, texture, and appearance, ensure the consistent dispersion of flavors and aromas, and ensure the quality and stability of beverages during shelf-life. Flavors and sweeteners added to beverages can be first incorporated into an emulsion and then added to the beverage, to provide significant improvements in many of these beverage attributes.

One of the primary challenges in the formulation of food products, especially those involving emulsions, is maintaining stability. Preservatives in the food industry prevent spoilage and extend shelf life by inhibiting the growth of microorganisms. Products like lotions, creams, and serums, which are often emulsions, require stabilization and preservation to maintain their efficacy and safety. Emulsions-mixtures of oil and water, require stabilization to maintain their form, which is often achieved using synthetic preservatives. Emulsions are inherently unstable due to the natural tendency of oil and water to separate. Stabilizing these emulsions typically requires the use of emulsifiers and preservatives, many of which are synthetic. There is increasing demand for natural alternatives to synthetic preservatives due to their potential health risks.

Traditional preservatives in the food and other consumer products industries primarily consist of synthetic chemicals that inhibit the growth of microorganisms and stabilize emulsions. These synthetic preservatives, while effective, pose potential health risks and have led to increased consumer demand for natural alternatives. Various attempts have been made to use natural substances as preservatives, such as essential oils and plant extracts, but these solutions often fall short in terms of effectiveness and stability.

Therefore, there is a need for an approach to prepare stable emulsions without the need for synthetic preservatives, using safe, natural alternatives.

### SUMMARY

According to a first aspect, an oil-in-water emulsion composition includes an oil phase that includes about 0.01 wt. % to about 30 wt. %, based on a total weight of the emulsion, of a flavorant; and optionally about 0.01 wt. % to about 10 wt. % based on the total weight of the emulsion, of an emulsifier adjuvant; and a continuous aqueous phase which includes about 0.01 wt. % to about 30 wt. %, based on the total weight of the emulsion, of a preservative comprising one or more vitamins and salts thereof; about 0.01 wt. % to about 10 wt. %, based on the total weight of the emulsion, of an emulsifying agent; and water.

In some embodiments, the oil-in-water emulsion composition includes an aqueous phase which includes about 0.001 wt. % to about 10 wt. %, based on the total weight of the emulsion, of a preservative comprising one or more vitamins and/or a salts thereof. Suitable vitamins and vitamin salts include ascorbic acid (Vitamin C), tocopherol (Vitamin E), vitamin A carotene, derivatives thereof and salts thereof. In some embodiments, the vitamin comprises vitamin C, vitamin E, and derivatives thereof. In some embodiments, the vitamin may be ascorbic acid, α-tocopherol, β-tocopherol, γ-tocopherol, δ-tocopherol, ε-tocopherol, α-tocotrienol, β-tocotrienol, γ-tocotrienol, or δ-tocotrienol. In some embodiments, the vitamin salt may be sodium ascorbate, calcium ascorbate, potassium ascorbate, ascorbyl palmitate, sodium ascorbyl phosphate, and magnesium ascorbyl phosphate. In some embodiments, the oil-in-water emulsion composition comprises from about 0.001% to about 5% by weight, based on the total weight of the emulsion, of the total weight of the emulsion composition of the vitamin and/or a salt thereof.

In some embodiments, the oil phase comprises about 0.01 wt. % to about 10 wt. %, based on the total weight of the emulsion, of a flavorant. In some embodiments, the flavorant in the oil-in-water emulsion composition includes hop oil, cannabis oil, hemp oil, hop extract, carrier oil, flavorant blends, hop-derived flavorant compounds, non-hop derived flavorant compounds, or a combination of any two or more thereof. In some embodiments, the flavorant comprises one or more of terpene, terpene blends, thiols, ketones, esters, aldehydes, alcohols, polyfunctional alcohols, polyfunctional thiols, heterocycles, and phenolics. In some embodiments the flavorant comprises terpenes or a blend of terpenes.

In some embodiments, the emulsifying agent in the oil-in-water emulsion composition includes a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and a combination of any two or more thereof. In some embodiments, the emulsifying agent comprises a sunflower lecithin. In some embodiments, the oil-in-water emulsion composition comprises about 0.01% to about 5% by weight, based on the total weight of the emulsion, of the emulsifying agent.

In some embodiments, the emulsifier adjuvant in the oil-in-water emulsion composition may be citric acid, malic acid, tartaric acid, ascorbic acid, caffeic acid, ferulic acid, and salts thereof. In some embodiments, the oil-in-water emulsion composition comprises about 0.01% to about 5% by weight, based on the total weight of the emulsion, of an emulsifier adjuvant.

In some embodiments, the water is present in an amount corresponding to the remaining balance of material in the oil-in-water emulsion composition. In some embodiments, the oil-in-water emulsion composition is substantially free of weighting agents and gum acacia.

According to yet another aspect, provided is an oil-in-water emulsion composition which includes about 0.01 wt. % to about 8 wt. %, based on a total weight of the emulsion, of one or more vitamins; about 0.01 wt. % to about 8 wt. %, based on the total weight of the emulsion, of one or more vitamin salts; about 0.5 wt. % to about 8 wt. %, based on the total weight of the emulsion, of one or more flavorants; about 0.01 wt. % to about 5 wt. %, based on the total weight of the emulsion, of a sunflower lecithin; and the balance being water. In some embodiments, he oil-in-water emulsion composition is substantially free of a weighting agent and gum acacia.

According to another aspect, a product comprising the oil-in-water emulsion composition is an edible product, a flavor product, or an aroma product. In some embodiments, the edible product comprising a food or beverage product. In some embodiments, the edible product is a food or beverage product. In some embodiments, the beverage is beer, an alcohol containing beverage, or a non-alcohol containing beverage product. In some embodiments, the beverage product is a fermented beverage. In some embodiments, the fermented beverage comprises kombucha, beer, wine, or cider.

According to yet another aspect, provided is a method comprising: (i) providing an oil phase comprising a flavorant and optionally an emulsifier adjuvant; (ii) providing an aqueous phase comprising water, a preservative comprising a vitamin, and a salt thereof, an emulsifying agent, and optionally an emulsifier adjuvant; (iii) mixing the oil phase and the aqueous phase so as to obtain a pre-emulsion; and (iv) homogenizing the pre-emulsion to obtain an oil-in-water emulsion. In some embodiments, the homogenizing comprises a multi-stage homogenization process.

According to another aspect, provided is a method for stabilizing an oil-in-water emulsion, the method comprising adding a vitamin to the emulsion to control pH and adding a vitamin salt to the emulsion. In some embodiments, the vitamin may be ascorbic acid, tocopherol, and their derivatives. In some embodiments, the vitamin salt may be potassium ascorbate, sodium ascorbate, and their derivatives. In some embodiments, the method further comprises further comprising adding additional natural emulsifiers of gum arabic, ester gum, or acacia gum. In some embodiments, the pH of the emulsion is controlled within a range of about 3.0 to about 7.0. In some embodiments, the vitamin and vitamin salt are present in a weight ratio ranging from about 1:1 to about 1:5. In some embodiments, the stabilized oil-in-water emulsion is used for formulating beverages, sauces, or dressings.

According to another aspect, provided is a method for preserving food or beverage products, wherein the method includes (a) formulating the product with an emulsion containing oil and water; (b) stabilizing the emulsion by adding a preservative comprising vitamins and vitamin salts. In some embodiments, the vitamin may be ascorbic acid, tocopherol, or a derivative thereof. In some embodiments, the vitamin salt may be potassium ascorbate, sodium ascorbate, or a derivative thereof. In some embodiments, the method includes further stabilizing the emulsion by adding an antioxidant that may be vitamin A, beta-carotene, or lycopene.

According to one aspect, provided is a method which includes plating the oil-in-water emulsion composition onto wet or dry surfaces of an edible layer or film; and processing the edible layer or film to provide consumable product. In another aspect, provided is a method which includes plating the oil-in-water emulsion composition onto wet or dry particles; and processing the dry particles to provide consumable product. In yet another aspect, provided is a method which includes plating the oil-in-water emulsion composition onto wet or dry surfaces of an edible film or layer, or onto wet or dry particles; treating and drying the film, layer or particles, and processing the dry particles or film to provide consumable product. In some embodiments, the treating includes coating with another layer, agglomeration, encapsulation, or a combination of any two or more thereof. In some embodiments, the consumable product is a food or beverage product.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments, and does not pose a limitation on the scope of the claims unless otherwise stated. No language in the specification should be construed as indicating any non-claimed element as essential.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. As a non-limiting example, a reference to “X and/or Y” can refer, In some embodiments, to X only (optionally including elements other than Y); in another embodiment, to Y only (optionally including elements other than X); in yet another embodiment, to both X and Y (optionally including other elements).

Unless indicated otherwise, reference to “percent” is to be understood as “weight percent,” and reference to “ratio” is as a weight/weight ratio.

As used herein, the term “terpene compound” oil emulsion” or “w/o emulsion” refers to a composition where small droplets of water are immersed in oil or another liquid. Water is therefore the dispersed phase, while oil is the dispersion medium.

The term “emulsifier adjuvant” as used herein refers to an agent present in either the oil phase or water phase or both that enhances and/or modifies the action and/or effectiveness of an emulsifier.

As used herein, the term “flavoring agent” or “flavorant” is understood to mean a substance that is meant to impart and/or improve the flavor (taste) and/or aroma impression of substances e.g., food or other substances, and can include both natural and synthetic ingredients. For example, a flavorant can include an aroma and/or a flavor agent. The flavorants may include additional additive(s) that provide additional functional benefits.

The term “flavor enhancer” as used herein refers to substances added to supplement, enhance, or modify the original taste and/or aroma of a food, without imparting a characteristic taste or aroma of its own.

The term “full spectrum hop extract” as used herein refers to a hop material that has not been separated beyond the initial extract produced from the extraction process.

As used herein, the term “terpene compound” is understood to mean any organic compound that contains some isoprene subunit within its structure and their oxygenated derivatives.

The term “flavorant emulsion” as used herein refers to an emulsion in which one or more flavorants are incorporated.

As used herein, the term “substantially free” may refer to a composition that has little or no content of the stated component. For instance, “substantially free of weighting agent” refers to a composition that has little or no weighting agent, e.g., the content of weighting agent is less than about 0.1 wt. %, less than about 0.01 wt. %, less than about 0.001 wt. %, or less than about 0.0001 wt. % based on the weight of the composition. In some embodiments, the composition is free of the stated component.

In recent years, synthetic preservatives such have been rejected by many consumers and while natural antimicrobial agents have been explored, their role has not been fully realized or integrated into comprehensive formulations for food and beverage applications. In the case of emulsions, particularly oil-in-water emulsions, the role of a preservative goes beyond preventing the growth of microorganisms, as they are expected to be multifunctional and offer a broad spectrum of activity, sufficient solubility in water, have pH-independent activity, contribute to emulsion stability, and avoid interaction with other ingredients.

Consequently, the inventors, in their quest to replace synthetic preservatives, have discovered a natural, effective solution for preserving and stabilizing food and beverage products, which use natural ingredients, specifically vitamins and their salts, which offer multifunctional benefits. Vitamins and their salts play a crucial role in both food and beverage preservation due to their multifaceted properties and offer as promising natural alternatives due to their multifunctional properties. Vitamins, such as ascorbic acid (Vitamin C) and tocopherol (Vitamin E), provide significant potent antioxidants, protecting products from oxidation and thereby extending their shelf life. They also help maintain the desired pH levels (buffer). Further, vitamin salts, such as potassium ascorbate, are particularly useful for their antimicrobial properties by inhibiting the growth of harmful microorganisms, which is essential for preserving food products naturally. Vitamin salts also provide additional benefits. For example, these salts can stabilize emulsions through electrostatic repulsion. Electrostatic repulsion occurs when particles with the same electrical charge repel each other, preventing them from coming together and separating the emulsion. Their ability to stabilize emulsions through electrostatic repulsion, also helps in preventing the separation of oil and water phases. Advantageously, the inventors discovered that this property is particularly useful in maintaining the consistency and texture of food products that are emulsions, such as dressings, sauces, and beverages.

Moreover, both vitamins and their salts exhibit antimicrobial properties. They can inhibit the growth of harmful microorganisms, which is essential for the natural preservation of food products. This antimicrobial action, combined with their antioxidant and pH-stabilizing properties, makes vitamins and their salts highly effective as natural preservatives.

In sharp contrast to conventional preservatives or antimicrobial agents used preparation of oil-in-water emulsions, it was surprisingly found by the inventors that that by leveraging the combined effects of antioxidant properties of vitamins such as ascorbic acid (Vitamin C) and tocopherol (Vitamin E), and the stabilizing and antimicrobial properties of vitamin salts such as potassium ascorbate, the increasing consumer demand for natural, safe, and effective ingredients in food and beverage products can be met. The present technology thus advantageously provides compositions and methods which utilize vitamins and their salts in emulsions, not only to provide antimicrobial protections, but also to maintain the stability through electrostatic repulsion, extend shelf life, and control pH levels of emulsions.

Disclosed are oil-in-water emulsions, compositions, consumer products including such emulsion compositions, and methods of preparation of such emulsion compositions. In some embodiments, the emulsion compositions include an oil phase comprising one or more flavorant additives and one or more emulsifier adjuvants; and an aqueous phase comprising water and one or more emulsifying agents.

The emulsion compositions described herein include one or more preservatives. Suitable preservatives include, but are not limited to, Vitamins (e.g., vitamin C/ascorbic acid, vitamin E/tocopherol) or a salt thereof (e.g., potassium ascorbate), organic acids (e.g., citric acid), enzymes (e.g., lysozyme), lactoperoxidase, lactoferrin, peptides, polysaccharides (e.g., chitosan), polyphenols, and essential oils, salts and derivatives thereof, and the like, or a combination of two or more thereof. Suitable vitamins and derivatives thereof may include, without limitation, vitamin E, and related derivatives, such as tocotrienols, α-, β-, γ-, δ-, and e-tocopherol, and their derivatives, such as the corresponding acetates and succinates and α-, β-, γ-, and δ-tocotrienol; Vitamin C and related derivatives, e.g., ascorbyl palmitate. Suitable vitamin salts include, but are not limited to, sodium, calcium, potassium, and magnesium salts, e.g., sodium ascorbate, calcium ascorbate, potassium ascorbate, sodium ascorbyl phosphate, and magnesium ascorbyl phosphate. Suitable essential oils and extracts may include, but are not limited to, plant based oils and extracts obtained from aniseed, basil, calms, camphor, cedar wood, cinnamon, clove, eucalyptus, geranium, ginger, lavender, lemon, lemongrass, lime, marjoram, mint, nutmeg, oregano, rosemary, sage, tea leaves, vetiver, and winter green. In some embodiments, the one or more preservatives includes ascorbic acid, tocopherol, and derivatives thereof. In some embodiments, the one or more preservatives includes potassium ascorbate, sodium ascorbate, and derivatives thereof. In some embodiments, the one or more preservatives includes ascorbic acid and/or a salt thereof.

The emulsion compositions may include a combination of vitamins and vitamin salts. Vitamins are used to control the pH, making emulsions possible despite the high acidity of some emulsion components such as terpenes/flavors. The pH of the emulsion can be maintained, for example, within the range of about 2.0 to about 10.0, preferably about 3.0 to about 7.0 to optimize the stability and antimicrobial efficacy. Salts derived from the vitamins are used to stabilize the emulsions through electrostatic repulsion as well as steric hindrance effects often focus on intramolecular interactions. steric hindrance significantly reduces the chances of coalescence, where two droplets merge to form a larger droplet. The use of vitamins and vitamin salts combination is instrumental in maintaining the stability and uniformity of the emulsion over time. Suitable vitamins and vitamin salts include ascorbic acid (Vitamin C), tocopherol (Vitamin E), derivatives thereof and salts thereof. In some embodiments, the one or more preservatives includes ascorbic acid and sodium ascorbate. In some embodiments, the one or more preservatives includes ascorbic acid and potassium ascorbate.

The vitamin and vitamin salt are present in a weight ratio ranging from 0.5:1 to 1:10, including without limitation, about 0.65:1 to about 1:8, about 0.75:1 to about 1:7.5, about 0.9:1 to about 1:6, about 1:1 to about 1:5, about 1:1 to about 1:4.5, or about 1:1 to about 1:4, and ratios in between and including the two values. In any embodiment, the ratio of vitamin to vitamin salt may range from about 1:1 to about 1:5.

The one or more preservatives may constitute about 0.0001% to about 30% by weight of the total weight of the emulsion composition. In some embodiments, the one or more preservatives may constitute up to about 30% by weight of the total emulsion composition, including up to about 20%, up to about 10%, up to about 5%, up to about 2%, up to about 1% or up to about 0.1% by weight of the total weight of the emulsion composition. In some embodiments, the one or more preservatives constitute at least about 0.0001% by weight of the total weight of the emulsion composition, including at least about 0.001%, at least about 0.01%, at least about 0.05%, at least about 0.1%, at least about 0.5%, at least about 1% or at least about 2% by weight. In some embodiments, the one or more preservatives constitute about 0.0001% to about 30% of the total weight of the composition, including without limitation, about 0.001% to about 20%, about 0.005% to about 15%, about 0.01% to about 10%, about 0.05% to about 8%, about 0.1% to about 5%, about 0.1% to about 3%, or about 0.1% to about 2% of the total weight of the emulsion composition, or any range including and/or in-between any two of these values. In certain embodiments, the preservatives is present in an amount of from about 0.001 wt. % to about 10 wt. %, based on the total weight of the of the emulsion composition.

The emulsion compositions may include one or more emulsifying agents, including natural and synthetic emulsifiers. The emulsifying agents may be included in the water phase, oil phase, or both. Suitable emulsifying agents include, but are not limited to, phospholipids (e.g., lecithin), proteins, whey proteins, amino acids, potassium sorbate, sorbitan monooleate, sorbitan monolaurate (SPAN® 20), sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, and the like and a combination of any two or more thereof. In some embodiments, the emulsifying agents include soy lecithin, sunflower lecithin, rapeseed lecithin, canola lecithin, safflower lecithin, egg lecithin, and the like or combinations thereof. In some embodiments, the emulsifying agent includes a sunflower phospholipid (sunflower lecithin), e.g., from Perimondo, New York, under the brand names of Sunlipon®, including Sunlipon® 90, Sunlipon® 65, Sunlipon® 50, which are phospholipids containing at least about 50% or at least about 60% phosphatidylcholine from sunflower lecithin. In some embodiments, the emulsifying agent includes proteins, e.g., chickpea protein, pea protein (Pisum sativum), pea protein isolates, fava bean proteins, oat proteins, oat protein concentrates, barley proteins, barley protein concentrates, sesame seed proteins, sesame protein concentrates, zein (from corn), pulse proteins, defatted plant proteins, seed storage proteins, almond (Prunus dulcis L.) protein isolates, canola protein isolates, and the like or a combination of any two or more thereof. In some embodiments, the emulsifying agent includes whey protein concentrates (WPC), hydrolyzed whey protein concentrates, whey protein isolates (WPI), egg white proteins, gelatins, or a combination of any two or more thereof. In some embodiments, the emulsifying agents include amino acids, e.g., glycine, proline, hydroxyproline, phospholipids and the like or a combination of any two or more thereof. In some embodiments, the emulsifying agent includes one or more of gum arabic, ester gum, and acacia gum.

When included in the emulsion composition, either in the oil phase or the water phase or both, the emulsion composition may include about 0.001% to about 20% of emulsifying agents by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the emulsifying agent is present in an amount of from about 0.001 wt. % to about 20 wt. %, based on the total weight of the of the emulsion composition.

In some embodiments, the emulsion compositions described herein are substantially free of a weighting agent and gum acacia. Commonly used weighting agents include, but are not limited to brominated vegetable oil (BVO), glycerol ester of wood rosin/glyceryl abietate (ester gum), sucrose acetate isbutyrate (SAIB), sucrose octa-isobutyrate, sucrose octa-acetate, sucrose hepta-isobutyrate, sucrose octa-propionate, propylene glycol dibenzoate, glycerol tribenzoate, methyl ester of hydrogenated rosin, calcium carbonate, manganese tetraoxide, and combinations thereof. In some embodiments, the emulsion compositions contains less than about 0.1 wt. %, less than about 0.01 wt. %, less than about 0.001 wt. %, or less than about 0.0001 wt. %, of the weighting agent (e.g., ester gum, BVO, SAIB, etc.) and gum acacia. In some embodiments, the emulsion compositions described herein are free any weighting agent and gum acacia, meaning that the weighting agent (e.g., ester gum, BVO, SAIB, etc.) and gum acacia is completely absent from the emulsion composition or that the emulsion composition includes 0 wt. % of a weighting agent.

The emulsion compositions may include a flavorant. They can be used as such or diluted in a suitable carrier including but not limited to triacetin, triethyl citrate, limonene, or other common carriers. Suitable flavorants may include natural, plant-derived compounds or synthetic compounds, and are derived or prepared based on certain specific desired taste and aroma characteristics. For example, certain flavorants are derived from a plant of Humulus lupulus or from Cannabis sativa. Certain flavorants are derived from or created to mimic the flavorants of products such as fruits, spices, herbs, flowers and the like, or combinations thereof. For example, the flavorant can be selected, e.g., based on the desired aroma and/or flavor characteristics (e.g., fruity, citrus-like, flowery, spicy/herbal, tropical, earthy, piney, and the like).

Other suitable flavorants for making flavorant emulsions may include, but are not limited to, plant essential oils; botanical extracts (e.g., extracts from plants and plant materials), plant proteins, polysaccharides, starches, oils, hydrocolloids, glucans; natural and artificial flavorants (e.g., substances added to impart aroma and/or flavor); natural and artificial flavor enhancers (e.g., substances added to supplement, enhance, or modify the original taste and/or aroma without imparting a characteristic taste or aroma of their own); natural and artificial flavoring agents and adjuvants (e.g., substances added to impart or help impart a taste or aroma in food); natural and artificial sweeteners-both nutritive and non-nutritive; natural and artificial antioxidants and their salts (e.g., butylated hydroxyanisole (BHA) and butylated hydroxytoluene (BHT), ferulic acid, caffeic acid, etc.); natural and artificial vitamins and their salts (e.g., vitamin c (ascorbic acid), sodium ascorbate, potassium ascorbate, vitamin e, vitamin b, vitamin k, etc.); natural and artificial nutrient supplements (e.g., substances necessary for the body's nutritional and metabolic processes, such as calcium, magnesium, potassium, etc.); antimicrobial agents (e.g., substances used to preserve food by preventing the growth of microorganisms and spoilage, including fungistats, mold inhibitors, and preservatives such as sorbic acid, and benzoate, suitable for use in consumable and topically applied substances); flavorants derived from or mimicking fruits, spices, herbs, flowers, and the like and combinations thereof; blends of plant-based and non-plant-based flavors (e.g., sweeteners, acids, salts, bittering agents, vitamins, minerals, proteins, hydrocolloids, carbohydrates, fats, oils, waxes, gums, and resins); celluloses and hemi-celluloses, other cellulosic materials, lignins, soluble and insoluble fiber, pectins, tannins, and particulate materials from plants; proteins, polysaccharides, sugars, starches, hydrocolloids, gums, oils, antioxidants, glucans, and acids: found in barley and oats; volatile and semi-volatile compounds from plants and plant materials: including terpenes, terpenoids, terpene blends, esters, ketones, alcohols, and polyfunctional thiols; compounds found in hops: resins, oils, terpenes, waxes, tannins, proteins, pectins, cellulosic materials, alpha-acids, beta-acids, iso-alpha acids, isomerized and un-isomerized acids, rho iso-extract, tetra iso-extract, xanthohumol, polyphenols, and combinations thereof; and compounds found in cannabis (e.g., resins, oils, terpenes, waxes, tannins, proteins, pectins, cellulosic materials, cannabidiol (CBD), cannabidiolic acid (CBDA), tetrahydrocannabinol (THC), tetrahydrocannabinolic acid (THCA), cannabigerol (CBG), cannabichromene (CBC), cannabinol (CBN), cannabielsoin (CBE), iso-tetrahydrocannabinol (iso-THC), cannabicyclol (CBL), cannabicitran (CBT), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannflavin A, B or C, polyphenols, salts thereof, derivatives thereof, cannabis oil, cannabis extract and combinations thereof).

In some embodiments, the flavorant may include hop oil (e.g., hop essential oil, hop oil, full spectrum hop extract), hop extract (e.g., rho iso-extract, tetra iso-extract), hop acids (e.g., alpha-acids, beta-acids, iso-alpha acids, isomerized and un-isomerized acids), flavonoids (e.g., xanthohumol), polyphenols, flavorant blends, other hop derived compounds such as the salt forms of alpha-acids, beta-acids, polyphenols, etc., or non-hop derived flavorant compound, or a combination of any two or more thereof. In at least one embodiment, the flavorant may be emulsified into a water-soluble liquid or water-soluble powder. In some embodiments, the flavorant may include exogenously added hop oil. In some embodiments, the flavorant may be infused into hop materials. In other embodiments, the flavorant can be used as such and added directly to consumable products without being infused into hop materials. In some embodiments, The flavorant may be incorporated into a carrier system to provide a flavorant matrix. The flavorant matrix may then be exogenously added, emulsified, and added or infused into a hop material and then added to the composition.

In some embodiments, the flavorant may be cannabis or hemp based, including extracts of cannabis and hemp. In some embodiments, the flavorant may include cannabinoid compounds. In some embodiments, the flavorant may include a terpene compound, a cannabinoid active agent, and an organosulfur compound. In some embodiments, the flavorant includes bittering acids, and wherein the un-isomerized bittering acids are emulsified to increase water solubility. In some embodiments, the flavorant includes un-isomerized bittering acids, and wherein the un-isomerized bittering acids are emulsified to increase water solubility.

In some embodiments, the flavorant may include ‘flavor enhancers’ such as natural and artificial edible acids and their salts (e.g., food-grade acids and their salts); and fruit acids and their salts (e.g., tartaric acid, citric acid, malic acid, magnesium citrate, αsodium citrate, potassium citrate, potassium bitartrate, potassium tartrate, sodium tartrate).

In some embodiments, the flavorant(s) may include, but are not limited to terpenes, terpenoids, terpenes, terpenoids, or blends of terpenes. In some embodiments, the flavorant includes terpenes. Illustrative terpenes include, but are not limited to, α-bisabolol, borneol, camphene, camphor, β-caryophyllene, γ-3-carene, caryophyllene oxide, α-cedrene, β-eudesmol, fenchol, geraniol, guaiol, α-humulene, isoborneol, limonene, linalool, menthol, myrcene, nerol, cis-ocimene, trans-ocimene, α-phellandrene, α-pinene, β-pinene, sabinene, α-terpinene, α-terpineol, terpinolene, α-guaiene, elemene, farnesene, germacrene, guaiol, bergotamene, thujene, ylangene, sabinene hydrate, pinanol, selina-3,7(11)-diene, eudesm-7(11)-en-4-ol, valencene, and the like and combinations and blends thereof. In some embodiments, the flavorants include commercially available terpene blends.

In some embodiments, the flavorants may include an organosulfur compound. Suitable organosulfur compounds include, without limitation, prenyl mercaptan, 2-methylthiophene, 3-methylthiophene, diprenyl disulfide, 3-methyl-2-buten-1-yl thiolacetate, 3-methyl-1-[(3-methyl-2-buten-1-yl)sulfanyl]-2-butene, prenylmethylthiol (1-(methylsulfanyl)-3-methyl-2-butene), prenyl thioacetate, thiogeraniol, or a combination of any two or more thereof.

The one or more flavorants may constitute about 0.0001% to about 100% by weight of the total weight of the emulsion composition. In some embodiments, the emulsion composition may include up to about 30% of the one or more flavorants by weight of the total emulsion composition, including up to about 20%, up to about 10%, up to about 5%, up to about 2%, up to about 1% or up to about 0.1% by weight of the total weight of the emulsion composition. In some embodiments, the emulsion composition may include at least about 0.0001% of flavorants by weight of the total weight of the emulsion composition, including at least about 0.001%, at least about 0.01%, at least about 0.05%, at least about 0.1%, at least about 0.5%, at least about 1% or at least about 2% by weight. In some embodiments, the emulsion composition may include about 0.0001% to about 30% of flavorants of the total weight of the composition, including without limitation, about 0.001% to about 20%, about 0.005% to about 15%, about 0.01% to about 10%, about 0.05% to about 8%, about 0.1% to about 5%, about 0.5% to about 5%, or about 1% to about 5% by weight of the total weight of the emulsion composition, or any range including and/or in-between any two of these values. In certain embodiments, the flavorant may be present in an amount of from about 0.001 wt. % to about 10 wt. %, based on the total weight of the emulsion composition.

The emulsion compositions may further include, either in the oil phase, the aqueous phase or both, additional additives that may provide additional benefits such as enhancements to texture, appearance, stability (chemical, physical, and microbiological stability), shelf-life and other functional benefits. Suitable additional additives include, but are not limited to, antimicrobial agents (e.g., substances used to preserve food by preventing the growth of microorganisms and subsequent spoilage, including fungistats, mold and rope inhibitors, and other effects listed by the national academy of sciences/national research council under “preservatives”); antioxidants (e.g., substances used to preserve food by retarding deterioration, rancidity, or discoloration due to oxidation); colors and coloring adjuncts (e.g., substances used to impart, preserve, or enhance the color or shading of food, including color stabilizers, color fixatives, and color-retention agents); curing and pickling agents (e.g., substances that impart a unique flavor and/or color to food, usually increasing shelf life stability); drying agents (e.g., substances with moisture-absorbing abilities, used to maintain an environment of low moisture); enzymes (e.g., enzymes used to improve food processing and the quality of the finished food); firming agents (e.g., substances added to precipitate residual pectin, strengthening the supporting tissue and preventing collapse during processing); flour treating agents (e.g., substances added to milled flour to improve its color and/or baking qualities, including bleaching and maturing agents); formulation aids (e.g., substances used to promote or produce a desired physical state or texture in food, including carriers, binders, fillers, plasticizers, film-formers, and tableting aids); humectants (e.g., hygroscopic substances incorporated in food to promote moisture retention, including moisture-retention agents and antidusting agents); leavening agents (e.g., substances used to produce or stimulate the production of carbon dioxide in baked goods to impart a light texture, including yeast, yeast foods, and calcium salts listed under “dough conditioners”); nutrient supplements (e.g., substances necessary for the body's nutritional and metabolic processes); oxidizing and reducing agents (e.g., substances that chemically oxidize or reduce another food ingredient, thereby producing a more stable product, including effects listed under “dough conditioners”); pH control agents (e.g., substances added to change or maintain active acidity or basicity, including buffers, acids, alkalis, and neutralizing agents); processing aids (e.g., substances used as manufacturing aids to enhance the appeal or utility of a food or food component, including clarifying agents, clouding agents, catalysts, flocculents, filter aids, and crystallization inhibitors); sequestrants (e.g., substances that combine with polyvalent metal ions to form a soluble metal complex, improving the quality and stability of products); solvents, carriers and vehicles (e.g., substances used to extract or dissolve another substance); stabilizers and thickeners (e.g., substances used to produce viscous solutions or dispersions, to impart body, improve consistency, or stabilize emulsions, including suspending agents, bodying agents, setting agents, jellying agents, and bulking agents); surface-active agents (e.g., substances used to modify surface properties of liquid food components for various effects, including solubilizing agents, dispersants, detergents, wetting agents, rehydration enhancers, whipping agents, foaming agents, and defoaming agents); synergists (e.g., substances that react with another food ingredient to produce an effect different or greater than the sum of the effects produced by the individual ingredients); texturizers (e.g., substances that affect the appearance or feel of the food); acids, including inorganic and organic acids and their salts (e.g., citric acid, tartaric acid, malic acid, folic acid, fumaric acid, lactic acid, acetic acid, phosphoric acid, ascorbic acid); salts including hydroxides, carbonates, bicarbonates, chlorides, gluconates, acetates, sulfides and sulfides of sodium, potassium, calcium, magnesium, and the like (e.g., chlorides, such as sodium chloride, potassium chloride, and magnesium chloride; carbonate salts, such as sodium carbonate, potassium carbonate, and calcium carbonate; bicarbonate salts, such as sodium bicarbonate; phosphate salts, such as disodium hydrogen phosphate, trisodium phosphate, dipotassium hydrogen phosphate, and tripotassium phosphate; sodium polyphosphate; citrate salts, such as sodium citrate; hydroxides such as sodium hydroxide, potassium hydroxide, magnesium hydroxide; acetates such as sodium acetate, potassium acetate; lactates such as sodium lactate, calcium lactate, magnesium lactate); and the like, or combinations thereof. Depending upon the end application, the compositions may include other ingredients, such as surfactants, co-solvents, propellants, other flavoring agents, medicinal agents, perfumes, stabilizers, thickeners, binders, essential oils, water, sweeteners, gelatin, food additives, colorants, carriers, excipients, diluents, and the like or a combination of any two or more thereof.

In some embodiments, the oil-in-water emulsion composition is substantially free of synthetic preservatives and/or antioxidants, such as sorbates and polysorbates. In some embodiments, the oil-in-water emulsion composition is substantially free of potassium sorbate. In some embodiments, the oil-in-water emulsion composition is substantially free of polysorbates. In some embodiments, the oil-in-water emulsion composition is substantially free of quilaja. In some embodiments, the oil-in-water emulsion composition exhibits improved stability as compared to an identically formulated composition containing a synthetic preservative and/or an antioxidant.

When included in the emulsion composition, the emulsion composition may include about 0.001% to about 20% of the one or more additional additives by weight of the total weight of the emulsion composition, including without limitation, about 0.005% to about 15%, about 0.01% to about 10%, about 0.05% to about 8%, about 0.1% to about 5%, about 0.1% to about 3%, or about 0.1% to about 2% by weight of the total weight of the emulsion composition or any range including and/or in-between any two of these values. In certain embodiments, the additional additives is present in an amount of from about 0.001 wt. % to about 10 wt. %, based on the total weight of the of the emulsion composition.

The emulsion compositions may include one or more emulsifier adjuvants. Suitable emulsifier adjuvants may include, but are not limited to, acids, salts, components of hop materials, and other emulsion composition components. Illustrative emulsifier adjuvants may include, but are not limited to chitosan, inulin, carrageenan, flaxseed mucilage, water soluble fraction of almond gum, maltodextrins, carbohydrates such as sugars (e.g., sucrose, glucose, fructose, trehalose, maltose, mannose; starches and modified starches (e.g., corn starch, rice starch, quinoa starch, mucunae bean starch (Mucuna pruriens), oat beta glucans, barley beta glucans, pectin, low methoxyl pectin, pullulan, dextran, citric acid, tartaric acid, caffeic acid, ferulic acid, sodium citrate, potassium citrate, hop acids (e.g., both isomerized and un-isomerized acids), rho iso-extract, tetra iso-extract, xanthohumol, Vitamin B, Vitamin K, and the like or a combination of any two or more thereof. Some emulsifier adjuvants can be multifunctional, possessing both stability to the emulsion system and acting as a flavor enhancer (e.g., citric acid and salts thereof).

The emulsifier adjuvants can be introduced separately in either the oil phase or the water phase prior to forming the emulsion. In some embodiments, the emulsifier adjuvants are included in the oil phase. In some embodiments, the emulsifier adjuvants are included in the water phase. In some embodiments, the emulsifier adjuvants are included in both the oil phase and the water phase. In some embodiments, the emulsifier adjuvants are simultaneously in both the oil phase and the water phase prior to forming the emulsion. Some of the non-limiting benefits associated with the use of an emulsifier adjuvant include, elimination of weighting agents, reduced turbidity, enhanced ease of emulsion formation, increased emulsion stability, decreased loss of flavor volatiles, and extended emulsion shelf-life.

In some embodiments, the emulsion composition may include about 0.0001% to about 15% of emulsifier adjuvants by weight of the total weight of the emulsion composition. In some embodiments, the emulsion composition include up to about 10% of emulsifier adjuvants by weight of the total emulsion composition, including up to about 8%, up to about 6%, up to about 5%, up to about 2%, up to about 1% or up to about 0.1% by weight of the total weight of the emulsion composition. In some embodiments, the emulsion composition include at least about 0.0001% of emulsifier adjuvants by weight of the total weight of the emulsion composition, including at least about 0.001%, at least about 0.01%, at least about 0.05%, at least about 0.1%, at least about 0.5%, at least about 1% or at least about 2% by weight. In some embodiments, the emulsion compositions include about 0.0001% to about 15% of emulsifier adjuvants of the total weight of the composition, including without limitation, about 0.001% to about 12%, about 0.005% to about 10%, about 0.01% to about 8%, about 0.05% to about 6%, about 0.1% to about 5%, about 0.1% to about 3%, or about 0.1% to about 2% by weight of the total weight of the emulsion composition, or any range including and/or in-between any two of these values. In certain embodiments, the emulsifier adjuvant is present in an amount of from about 0.001 wt. % to about 10 wt. %, based on the total weight of the of the emulsion composition. In certain embodiments, the emulsifier adjuvant is present in an amount of from about 0.01 wt. % to about 5 wt. %, based on the total weight of the of the emulsion composition.

The amount of acids and salts described herein, e.g., vitamin acids and salts, in the water phase can be adjusted to optimize emulsion stability. For example, the concentration of the salts and acids in the water phase can be altered to optimize the emulsion properties such as density, pH, turbidity, particle size, particle size distribution, stability, and consistency.

In one aspect, the present technology provides a composition in the form of an oil-in water emulsion comprising: an oil phase comprising from about 0.01 wt. % to about 30 wt. % of one or more flavorants; and a continuous aqueous phase comprising water, from about 0.001 wt. % to about 10 wt. % of one or more preservatives and about 0.01 wt. % to about 15 wt. % of an emulsifying agent, wherein all weight percentages are based on the total weight of the composition. In some embodiments, the preservative includes one or more of vitamins, derivatives thereof and salts thereof. In some embodiments, the preservative may be ascorbic acid, tocopherol, potassium ascorbate, or sodium ascorbate. In some embodiments, the vitamin is ascorbic acid and the vitamin salt is potassium ascorbate. In some embodiments, the emulsifying agent is lecithin (e.g., sunflower lecithin). In some embodiments, the emulsifying agent may be gum arabic, ester gum, or gum acacia. In some embodiments, the emulsifying agent includes a sunflower phospholipid. In some embodiments, the flavorant includes a terpene or a blend of terpenes. In some embodiments, the flavorant includes hop extracts.

The emulsion compositions described herein have several advantages. For example, the emulsion compositions may exhibit improved stability as compared to an identically formulated composition not containing vitamins and vitamin salts or containing synthetic preservatives. Improved stability may include short-term stability, long-term stability, or both. For example, improved stability, In some embodiments, may include improved initial stability, e.g., particle size of the initial solution. The emulsion compositions described herein contain vitamins which aid in controlling the pH, and vitamin salts which help to stabilize the emulsions through electrostatic repulsion as well as steric hindrance effects often focus on intramolecular interactions. Steric hindrance significantly reduces the chances of coalescence, where two droplets merge to form a larger droplet. Thus, the emulsion compositions described herein maintain their stability and uniformity over time. Additionally, the emulsion compositions described herein provide a natural, safe, and effective alternative for use in consumer products, e.g., food and beverages products. The present technology is associated with advantages such as elimination of weighting agents, reduced processing times, enhanced regulatory compliance, lower production costs, preservation of flavor and aroma, providing clear beverage emulsions and increasing the emulsion stability and shelf-life. The compositions and methods described herein allow quick, consistent, and easy incorporation of aroma and/or flavor enhancement into distinct types of products. Additionally, the use of synthetic is avoided thereby ensuring compliance with regulatory standards, consumer preference and enhancing the safety profile of the emulsions. The present technology further improves the retention of volatile flavor and aroma compounds during emulsification, resulting in superior sensory quality of the final product. Finally, the present technology enhances the stability and shelf-life of the emulsion compositions without the need for traditional synthetic antioxidants, preservatives, and stabilizers, ensuring consistent performance over time and creates stable oil-in-water emulsions that maintain clarity in products such as beverages, enhancing visual appeal and product quality.

The emulsion compositions described herein may be used in a variety of products including edible products, aerosol products, aroma products, flavor products, and other consumer products. The compositions may synergistically enhance the olfactory effects of products to which they are added. In certain embodiments, the compositions can be used as an additive to synergistically enhance the aroma and/or flavor of products such as edible products, aerosol products, aroma products, flavor products, and consumer products. In certain embodiments, the edible product is a food product or a beverage product.

The emulsion compositions described herein may be used in a wide variety of products including, but not limited to, baked goods and baking mixes (e.g., ready-to-eat and ready-to-bake products, flours, and mixes requiring preparation); alcoholic beverages (e.g., malt beverages, wines, distilled liquors, and cocktail mixes), nonalcoholic beverages (e.g., special or spiced teas, soft drinks, coffee substitutes, and fruit and vegetable flavored gelatin drinks); breakfast cereals (e.g., ready-to-eat, instant, and regular hot cereals); cheeses (e.g., curd and whey cheeses, cream, natural, grating, processed, spread, dip, and miscellaneous cheeses; confectionaries (e.g., chewing gum; gummies, candy, hard and soft candy, candy bars, chocolates, fudge, mints, and other chewy candies); coffee and tea (e.g., regular, decaffeinated, and instant types); condiments and relishes (e.g., plain seasoning sauces and spreads, olives, pickles, and relishes); confections and frostings (e.g., flavored frostings, marshmallows, baking chocolate, and various sugars); dairy product analogs and dairy based drinks (e.g., nondairy milk, creamers, coffee whiteners, toppings, and other nondairy products); egg products (e.g., liquid, frozen, or dried eggs); fats and oils (e.g., margarine, dressings, butter, salad oils, shortenings, and cooking oils); fish products (e.g., prepared main dishes, salads, appetizers, frozen meals, and spreads containing fish); fresh eggs (e.g., cooked eggs and dishes made from fresh shell eggs); fresh fish (e.g., fresh and frozen fish, shellfish, and other aquatic animals); fresh fruits and fruit juices (e.g., raw fruits, citrus, melons, berries, and home-prepared punches); fresh meat and meat products (e.g., fresh or home-frozen beef, veal, pork, lamb, or mutton, meat-containing dishes, salads, appetizers, frozen meals, and deli meat); fresh poultry and poultry products (e.g., fresh or home-frozen poultry and game birds, poultry and poultry-containing dishes, salads, appetizers, frozen meals, and sandwich ingredients); fresh vegetables (e.g., tomatoes, and potatoes, fresh and home-prepared vegetables); frozen dairy desserts and mixes (e.g., ice cream, ice milks, sherbets, and other frozen dairy desserts); fruit and water ices; gelatins, puddings, and fillings (e.g., flavored gelatin desserts, puddings, custards, parfaits, pie fillings, and gelatin base salads); grain products and pastas (e.g., macaroni and noodle products, rice dishes, and frozen multicourse meals); gravies and sauces (e.g., meat sauces, gravies, and various specialty sauces); hard candy and cough drops; herbs, seeds, spices, seasonings, blends, extracts, and flavorings; jams and jellies (e.g., home-prepared and commercially processed jams, jellies, fruit butters, preserves, and sweet spreads); milk and milk products (e.g., whole, low-fat, skim fluid milks, flavored milks, dry milks, toppings, snack dips, spreads, weight control milk beverages, and other milk origin products); nuts and nut products (e.g., whole or shelled tree nuts, peanuts, coconut, and nut spreads); plant protein products (e.g., meat, poultry, and fish substitutes, analogs, and extender products made from plant proteins); processed fruits and fruit juices (e.g., commercially processed fruits, salads, juices, punches, concentrates, and drink substitutes); processed vegetables and vegetable juices (e.g., commercially processed vegetables, dishes, frozen meals, and vegetable juices); snack foods (e.g., chips, pretzels, and other novelty snacks); soups and soup mixes (e.g., home-prepared and commercially made meat, fish, poultry, vegetable, and combination soups; white granulated sugar; granulated, liquid, and tablet sugar substitutes; sweet sauces, toppings, and syrups (e.g., chocolate, berry, fruit, corn syrup, and maple sweet sauces and toppings). These potential applications, illustrate the versatility and wide-reaching impact of the emulsion compositions provided in the disclosure.

In another aspect, the present technology relates to various products that may include the emulsion compositions described herein. Illustrative products include, without limitation, edible products, aerosol products, aroma products, or flavor products. In certain embodiments, an edible product comprising an emulsion composition described herein is provided. In certain embodiments, the edible product is a food or beverage product. In some embodiments, the present technology relates to beverage products that may include the emulsion compositions described herein. In certain embodiments, the beverage is a fermented beverage including but not limited to kombucha, beer, wine, cider. In certain embodiments, the beverage is beer, any alcohol containing beverage, or other non-alcohol beverage product. In certain embodiments, a flavor and fragrance product comprising the emulsion composition described herein is provided. In certain embodiments, a flavor and/or fragrance delivery system comprising the emulsion composition described herein is provided.

The emulsion compositions may be included in the products in an amount suitable to provide the desired stability or other property of the product, ranging from about 0.0001% to 50% by weight or volume, including from about 0.001% to 30%, about 0.05% to 20%, about 0.01% to 10%, about 0.01% to 5%, or about 0.01% to 3%, of the total weight or volume of the product, or any range including and/or in-between any two of these values For example, when used in a beverage, the emulsion compositions may be included in a concentration range of from about 0.01% to 10%, or about 0.05% to 8%, or about 0.1% to 5%, or about 0.5% to 3%, by volume, depending on the specific beverage formulation.

In another aspect, the present technology relates to methods for preparing an oil-in-water emulsion. For example, provided herein are methods for preparing an oil-in-water emulsion said method comprising: (i) providing an oil phase comprising one or more flavorant additives; (ii) providing an aqueous phase comprising water, one or more preservatives and one or more emulsifying agents; (iii) mixing the oil phase and the aqueous phase so as to obtain a pre-emulsion; and (iv) homogenizing the pre-emulsion to obtain an oil-in-water emulsion. In some embodiments, the homogenizing comprises a multi-stage homogenization process. The oil phase may be prepared by mixing the one or more flavorant additives. The aqueous phase is prepared by mixing the appropriate amount of preservatives (e.g., vitamins, vitamin salts), and distilled water and adding the emulsifying agent in to the water mixture with mixing. In some embodiments, the method includes using a high-shear mixing process to enhance the uniform distribution of the vitamins and vitamin salts,

In another aspect, the present technology provides methods for preparing a natural preservative and stabilizer for food and beverages. In yet another aspect, the present technology relates to methods for preserving food and beverages. The methods includes forming and stabilizing emulsion compositions for use in food and beverages by using natural preservative agents, wherein the emulsion compositions includes a plant-derived flavorant additive, salts, acids, and emulsifying agents.

In yet another aspect, the present technology provides methods for stabilizing oil-in-water emulsions and preserving products; wherein the method includes adding a vitamin to the emulsion to control pH and adding a vitamin salt to the emulsion to stabilize the emulsion through electrostatic repulsion and steric hindrance. The vitamin may be ascorbic acid or a tocopherol. The vitamin salt may be potassium ascorbate or sodium ascorbate. The methods may further include using the stabilized emulsion in food or beverage products as a natural alternative to synthetic preservatives. The methods may further include emulsifying one or more flavorant additives, in the presence of vitamins and/or vitamin salts and derivatives, into an oil-in-water emulsion or a multi-layered oil-in-water emulsion suitable for use in consumable substances and topically applied substances.

In one aspect, the present technology provides methods preserving products (e.g., food or beverage products); wherein the method includes formulating the product with an emulsion containing oil and water; and stabilizing the emulsion by adding a combination of vitamins and vitamin salts. The vitamin may be ascorbic acid or tocopherol. The vitamin salt may be potassium ascorbate or sodium ascorbate. The product may be a consumer product, such as a food product or a beverage product. Depending on the type of product, the emulsion can be further stabilized using an additional antioxidant (e.g., vitamin A, beta-carotene, and lycopene). The methods may further include utilizing the emulsion as a preservative to extend the shelf life of the product by providing antimicrobial, antioxidant, and pH-stabilizing properties. The stabilized emulsions may be used in the formulation of beverages, sauces, dressings, lotions, creams, or serums.

In one aspect, the present technology relates to methods for using the oil-in-water emulsions or multi-layered oil-in-water emulsions. The methods include, for example, plating the emulsion onto either wet or dry surfaces in the form of layers or films. Such films or edible layers may be used as final products or may undergo further treatment and/or processing as needed to form an edible layer or film that can be consumed or incorporated into a food product. In another embodiment, the methods include, for example, plating the emulsion onto either wet or dry particles Such particles may be used as final products or may undergo further treatment and/or processing as needed to form edible particles that can be consumed or incorporated into a food or beverage product, or that can be dissolved and/or dispersed in a consumable liquid. Further treatment or processing may include step such as e.g., drying, coating with another layer, agglomeration, encapsulation, mixing, blending, size classification, size reduction, milling, spherification, preservation, and the like and combinations of any two or more thereof.

According to one aspect, provided is a method comprising plating the oil-in-water emulsion compositions of the present technology onto wet or dry surfaces of an edible layer or film; and processing the edible layer or film to provide consumable product. In another aspect, provided is a method comprising plating the oil-in-water emulsion compositions of the present technology onto wet or dry particles; and processing the dry particles to provide consumable product. According to yet another aspect, provided is a method comprising plating the oil-in-water emulsion composition of the present technology onto wet or dry surfaces of an edible film or layer, or onto wet or dry particles; treating and drying the film, layer or particles, and processing the dry particles or film to provide consumable product. In some embodiments, the treatment may include coating with another layer, agglomeration, encapsulation, drying, or a combination of any two or more thereof, e.g., layer coating and drying, agglomeration and drying, encapsulation and drying, layer coating, agglomeration and drying, etc. The consumable product may include the food or beverage products, including fermented beverages such as kombucha, beer, wine, or cider.

According to one aspect, provided is a method comprising plating the oil-in-water emulsion composition onto wet or dry surfaces of an edible film or layer; and processing the edible layer or film to provide consumable product. In another aspect, provided is a method comprising plating the oil-in-water emulsion composition onto wet or dry particles; and processing the dry particles to provide consumable product. In yet another aspect, provided is a method comprising plating the oil-in-water emulsion composition onto wet or dry surfaces of an edible film or layer, or onto wet or dry particles; treating and drying the film, layer, or particles, and processing the dry particles or film to provide consumable product. In one embodiment, the treating comprises coating with another layer, agglomeration, encapsulation, drying, or a combination of any two or more thereof. In one embodiment, the consumable product is a food or beverage product.

The present technology is associated with advantages such as elimination of weighting agents, reduced processing times, enhanced regulatory compliance, lower production costs, preservation of flavor and aroma, providing clear beverage emulsions and increasing the emulsion stability and shelf-life. The present technology provides a formulation process that does not require weighting agents, thus reducing turbidity, and simplifying the emulsion creation, and streamlines the emulsification process by eliminating the need for lengthy hydration steps, thereby shortening the overall production time. The compositions and methods described herein allow quick, consistent, and easy incorporation of aroma and/or flavor enhancement into products. Additionally, the use of ingredients like BVO and gum acacia is avoided thereby ensuring compliance with regulatory standards and enhancing the safety profile of the emulsions, and the ingredient and processing costs are reduced by eliminating expensive and scarce components, making the production of flavorant emulsions more economical. The present technology further improves the retention of volatile flavor and aroma compounds during emulsification, resulting in superior sensory quality of the final product. Finally, the present technology enhances the stability and shelf-life of the emulsion compositions without the need for traditional stabilizers, ensuring consistent performance over time and creates stable oil-in-water emulsions that maintain clarity in beverages, enhancing visual appeal and product quality. The oil-in-water emulsions of the present technology exhibit a minimum fall in pH, turbidity, and particle size distribution (d50) over short and long term storage. In some embodiments, the oil-in-water emulsion compositions of the present technology exhibit improved stability as compared to a composition containing a weighting agent and gum acacia. In some embodiments, the oil-in-water emulsion compositions of the present technology exhibit improved stability as compared to an identically formulated composition containing a weighting agent and gum acacia. In some embodiments, the oil-in-water emulsion compositions of the present technology exhibit a stable particle size distribution on storage as compared to an identically formulated composition containing a weighting agent and gum acacia. In some embodiments, the oil-in-water emulsion compositions of the present technology exhibit a stable pH on storage as compared to an identically formulated composition containing a weighting agent and gum acacia. In some embodiments, the oil-in-water emulsion compositions of the present technology exhibit a stable or reduced turbidity on storage as compared to an identically formulated composition containing a weighting agent and gum acacia.

The present invention, thus generally described, will be understood more readily by reference to the following examples, which are provided by way of illustration and are not intended to be limiting of the present invention.

### EXAMPLES

Various embodiments will be further clarified by the following examples, which are in no way intended to limit this disclosure thereto. All amounts are in wt. %, based in the total weight of the emulsion composition, unless otherwise specified.

### Example 1: Preparation of Emulsion Composition with Vitamins and Vitamin Salts

Preparation of Oil Phase: Suitable amounts of oil-soluble terpenes are measured and slowly added directly to the water phase while stirring gently to avoid separation.

Preparation of Water Phase: Ascorbic acid, sodium ascorbate, sodium citrate, citric acid, and distilled water are sequentially added into a clean beaker. The solution is stirred continuously using a Silverson L5M-A mixer at low RPM to ensure full dissolution of the components. Suitable amount of Sunflower lecithin (Sunlipon® 65, phospholipids containing at least about 60% phosphatidylcholine from sunflower lecithin, Perimondo, New York, N.Y) is gradually added to the water phase. The solution is mixed for 10-15 min using a Silverson L5M-A mixer with a general mixing head, and its speed set to 5000 RPM. The mixing is done to ensure that the emulsifier fully dissolves, and the temperature is monitored throughout the process to ensure it does not rise above desired levels. The beaker sides and the mixing head are periodically scraped as necessary to prevent any material from sticking, which could cause uneven mixing or injury from buildup. The solution is allowed to return to room temperature naturally once mixing is complete. After dissolution is completed, the pH is checked using a pH meter and adjusted if necessary to optimize for stability and preservation.

Preparation of Pre-emulsion Solution: The oil phase is slowly added to the prepared water phase while controlling the rate of addition to prevent any sudden phase separation. After the oil phase has been added, the Silverson L5M-A mixer is switched to the emulsifying head and the speed is increased to 5000 RPM. The mixture is mixed for 10 min to ensure thorough emulsification and uniform consistency. The mixture is inspected to confirm even distribution of the oil droplets in the water phase. The solution is allowed to sit for 30 min to let any excess air bubbles escape, improving the overall stability of the pre-emulsion. De-aeration can also be assisted by a vacuum chamber or desiccator if needed.

Homogenization: Before starting the homogenization process, the cooling water system and digital pressure gauge are activated to maintain temperature control and monitor homogenization pressures. 200-500 mL of distilled water is added to the feed hopper to adjust the homogenizer parameters before processing the main batch. An APV 1000/2000 homogenizer is prepared by activating the cooling water system and digital pressure gauge. With 500 mL of the pre-emulsion in the feed hopper, the homogenizer is started and the pressure is adjusted to 10000-12000 psi for the first stage. The second-stage pressure is set to 20% of the first stage pressure (approximately 2000-2400 psi). Both the pressure and temperature are carefully monitored during this process to ensure the system operates within safe limits. The pre-emulsion is slowly fed into the homogenizer and processed twice to achieve optimal particle size reduction. The feed hopper is monitored to ensure it does not empty, thereby preventing cavitation. The temperature increases are monitored, ensuring they remain within a 5° C. rise per pass to maintain emulsion integrity. If necessary, external cooling methods are used to keep the temperature within range. The samples are collected during the second homogenization run for performing quality control testing which includes parameters like particle size, stability, and consistency. Once complete, the homogenizer pressure is disengaged by turning the hand wheels counterclockwise, bringing the pressure to zero safely.

### Example 2: Preparation of Comparative Emulsion Composition with Synthetic Preservative

Preparation of Oil Phase: Suitable amounts of oil-soluble terpenes are measured.

Preparation of Water Phase: Potassium sorbate and distilled water are sequentially added into a clean beaker. The solution is stirred continuously using a Silverson L5M-A mixer at low RPM to ensure full dissolution of the potassium sorbate. Suitable amount of Sunflower lecithin (Sunlipon®65, phospholipids containing at least about 60% phosphatidylcholine from sunflower lecithin, Perimondo, New York, N.Y) is gradually added to the water phase. The solution is mixed for 10-15 min using a Silverson L5M-A mixer with a general mixing head, and its speed set to 5000 RPM. The mixing is done to ensure that the emulsifier fully dissolves, and the temperature is monitored throughout the process to ensure it does not rise above desired levels. The solution is allowed to return to room temperature naturally once mixing is complete. After dissolution is completed, the pH is checked using a pH meter and adjusted if necessary to optimize for stability and preservation.

Preparation of Pre-emulsion Solution: The oil phase is slowly added to the prepared water phase while controlling the rate of addition to facilitate emulsion formation. After the oil phase has been added, the Silverson L5M-A mixer is switched to the emulsifying head and the speed is increased to 5000 RPM. The mixture is mixed for 10 min to ensure thorough emulsification and uniform consistency. The mixture is inspected to confirm even distribution of the oil droplets in the water phase. The solution is allowed to sit for 30 min to let any excess air bubbles escape, improving the overall stability of the pre-emulsion. De-aeration can also be assisted by a vacuum chamber or desiccator if needed. This process can be done in an inert atmosphere to minimize oxygen. Alternatively or additionally, the resulting solution can be purged to remove dissolved oxygen can be done. Lastly, an inert gas blanket can be applied to minimize oxygen incorporation.

Homogenization: Before starting the homogenization process, the cooling water system and digital pressure gauge are activated to maintain temperature control and monitor homogenization pressures. 200-500 mL of distilled water is added to the feed hopper to adjust the homogenizer parameters before processing the main batch. Add 500 mL of the pre-emulsion into the feed hopper, the homogenizer is started and the pressure is adjusted to 10000-12000 psi for the first stage. The second-stage pressure is set to 20% of the first stage pressure (approximately 2000-2400 psi). Both the pressure and temperature are carefully monitored during this process to ensure the system operates within safe limits, as well as monitoring emulsion temperature to ensure minimal off gassing. The pre-emulsion is slowly fed into the homogenizer and processed twice to achieve optimal particle size reduction. The feed hopper is monitored to ensure it does not empty, thereby preventing cavitation. The temperature increases are monitored, ensuring they remain within a 5-10° C. rise per pass to maintain emulsion integrity. If necessary, external cooling methods are used to keep the temperature within range. The samples are collected during the second homogenization run for performing quality control testing which includes parameters like particle size, zeta potential, pH, particle size range, turbidity, acidity, and consistency. Once complete, the homogenizer pressure is disengaged by turning the hand wheels counterclockwise, bringing the pressure to zero.

### Example 3: Oil-In-Water Emulsions with Vitamin Preservative

Inventive emulsion compositions were prepared using the method described in Example 1. To understand how different flavorant formulations influence different emulsion systems, 20 different flavorant formulations were studied. A listing of flavorant formulations tested, their flavor profiles, and their general chemical composition is provided in Table 1 below:

TABLE 1

| Flavorant | | |
|---|---|---|
| Formulation | Flavor profile | Chemical Composition |
| A | El dorado hops | terpenes, esters, aldehydes, volatile |
| | | sulfur compounds |
| B | Cascade hops | terpenes, esters, aldehydes, volatile |
| | | sulfur compounds |
| C | Centennial hops | terpenes, esters, aldehydes, volatile |
| | | sulfur compounds |
| D | Willamette hops | terpenes, esters, aldehydes, volatile |
| | | sulfur compounds |
| E | Galaxy Hops | terpenes, esters, aldehydes, volatile |
| | | sulfur compounds |
| F | Azacca Hops | terpenes, esters, aldehydes, volatile |
| | | sulfur compounds |
| G | Chinook hops | terpenes, esters, aldehydes, volatile |
| | | sulfur compounds |
| H | Strata hops | terpenes, esters, aldehydes, volatile |
| | | sulfur compounds |
| I | Citra hops | terpenes, esters, aldehydes, volatile |
| | | sulfur compounds |
| J | Mosaic hop | terpenes, esters, aldehydes, volatile |
| | | sulfur compounds |
| K | Nelson hops | terpenes, esters, aldehydes, volatile |
| | | sulfur compounds |
| L | Pineapple | terpenes, esters, aldehydes, volatile |
| | | sulfur compounds |
| M | Strawberry | terpenes, esters, aldehydes, volatile |
| | | sulfur compounds |
| N | Mango | terpenes, esters, aldehydes, volatile |
| | | sulfur compounds |
| O | King Louie | terpenes, esters, aldehydes, volatile |
| | | sulfur compounds |
| P | Pineapple | terpenes, esters, aldehydes, volatile |
| | Express | sulfur compounds |
| Q | Blackberry Kush | terpenes, esters, aldehydes, volatile |
| | | sulfur compounds |
| R | Gelato | terpenes, esters, aldehydes, volatile |
| | | sulfur compounds |
| S | SFV OG | terpenes, esters, aldehydes, volatile |
| | | sulfur compounds |
| T | Watermelon | terpenes, esters, aldehydes, volatile |
| | | sulfur compounds |
| U | Sour Tangie | terpenes, esters, aldehydes, volatile |
| | | sulfur compounds |
| V | Grapefruit Kush | terpenes, esters, aldehydes, volatile |
| | | sulfur compounds |
| W | Pink Rntz | terpenes, esters, aldehydes, volatile |
| | | sulfur compounds |
| X | White Rntz | terpenes, esters, aldehydes, volatile |
| | | sulfur compounds |

Using the procedure described in Example 1 emulsion systems were prepared, containing the inventive vitamin/vitamin salt preservative (EMP-010) and (EMP-01Q), for use in combination with 2% or 5% load of the various flavorant formulations A-T from Table 1, to study effect of changing emulsion systems and flavorants on emulsion properties of the resulting emulsion compositions. The emulsion systems EMP-010 and EMP-01Q are provided in Table 2 below. All amounts are in wt. %, based in the total weight of the emulsion composition, unless otherwise specified below.

TABLE 2

| | | Sodium | | | |
|---|---|---|---|---|---|
| Emulsion | Ascorbic | Ascor- | | Water, | Flavorant |
| System | Acid | bate | Sunlipon ®65 | Distilled | (wt. %) |
| EMP-01O | 0.04 | 0.03 | 2.00 | 95.93 | 2 |
| EMP-01Q | 0.03 | 0.02 | 2.50 | 92.45 | 5 |

### Example 4: Comparative Oil-In-Water Emulsions with Synthetic Preservative

Emulsion compositions were prepared using a control/comparative emulsion system (EMP-01R) with a synthetic preservative (e.g., potassium sorbate), instead of the vitamins and/or salts thereof, using the method described in Example 2. The comparative control emulsion compositions are listed in Table 3. All amounts are in wt. %, based in the total weight of the emulsion composition, unless otherwise specified below.

TABLE 3

| | | Emulsion System - EMP-01R | | | |
|---|---|---|---|---|---|
| Flavorant | | Citric | Sunlipon ® | Potassium | Water, |
| Formulation | wt. % | Acid | 65 | Sorbate | Distilled |
| A | 5 | 0.05 | 2.5 | 0.2 | 92.25 |
| B | 5 | 0.08 | 2.5 | 0.2 | 92.22 |
| C | 5 | 0.04 | 2.5 | 0.2 | 92.26 |
| D | 5 | 0.05 | 2.5 | 0.2 | 92.25 |
| E | 5 | 0.08 | 2.5 | 0.2 | 92.22 |
| F | 5 | 0.04 | 2.5 | 0.2 | 92.2 |
| G | 5 | 0.06 | 2.5 | 0.2 | 92.24 |

### Example 4: Stability Analysis of Emulsions

The inventive and comparative/control emulsion compositions prepared using the methods described in Examples 1-3 were tested for parameters like particle size, stability, and consistency. The results are shown in the Tables below. Table 4 shows particle size distribution data for control oil-in-water emulsions containing synthetic preservatives.

TABLE 4

| Emulsion | Flavor | | | |
|---|---|---|---|---|
| System | Formulation | d10 (μm) | d50 (μm) | d90 (μm) |
| EMP-01R | G | 0.08 | 0.128 | 0.194 |
| EMP-01R | C | 0.081 | 0.129 | 0.194 |
| EMP-01R | J | 0.079 | 0.124 | 0.187 |
| EMP-01R | B | 0.082 | 0.133 | 0.204 |
| EMP-01R | H | 0.13 | 0.213 | 0.32 |
| EMP-01R | K | 0.08 | 0.127 | 0.195 |
| EMP-01R | I | 0.078 | 0.125 | 0.195 |
| EMP-01R | D | 0.082 | 0.134 | 0.21 |
| EMP-01R | E | 0.079 | 0.127 | 0.197 |

Table 5 shows particle size distribution data for oil-in-water emulsions containing either emulsion system EMP-01Q (5% flavorant) with vitamins and/or vitamin salts and comparative emulsions EMP-01R (5% flavorant) containing a synthetic preservative (potassium sorbate).

TABLE 5

| Flavorant | Vitamin Preservative | Synthetic Preservative |
|---|---|---|
| Formulation | Particle D90 (nm) | Particle D90 (nm) |
| L | 206 | 338 |
| M | 254 | 241 |
| N | 201 | 192 |
| O | 225 | 170 |
| P | 285 | 186 |
| Q | 275 | 183 |
| R | 297 | 170 |
| S | 292 | 204 |
| T | 248 | 160 |

Table 6 shows accelerated shelf-life (ASL) study emulsions test data for emulsion composition storage made using EMP-010 emulsion system at 0-5 weeks at 45° C. The ASL oil-in-water emulsions test data shows minimum fall in pH, turbidity, and particle size distribution (d90) over 5 weeks.

TABLE 6

| Flavorant | | Week 0 | | | Week 1 | | | Week 2 | | |
|---|---|---|---|---|---|---|---|---|---|---|
| Formulation | Density | pH | D90 nm | Turbidity | pH | D90 nm | Turbidity | pH | D90 nm | Turbidity |
| T | 0.998 | 4.13 | 248 | 6.71 | 3.77 | 294 | 7 | 3.82 | 224 | 7.62 |
| L | 0.996 | 4.15 | 206 | 3.89 | 4.03 | 217 | 3.36 | 4.05 | 197 | 3.67 |
| M | 0.977 | 3.97 | 254 | 6.22 | 3.91 | 325 | 5.68 | 3.91 | 240 | 6.18 |
| N | 0.986 | 4.49 | 201 | 6.77 | 4.22 | 198 | 4.65 | 4.08 | 208 | 5.75 |
| O | 0.993 | 4.15 | 225 | 17.66 | 4.05 | 282 | 18.82 | 4.03 | 287 | 15.87 |
| P | 0.997 | 4.23 | 285 | 13.46 | 4.04 | 280 | 13.8 | 3.56 | 285 | 9.6 |
| Q | 0.996 | 4.31 | 275 | 12.95 | 4.29 | 266 | 10.39 | 4.16 | 287 | 10.28 |
| R | 0.995 | 4.21 | 297 | 14.17 | 3.89 | 277 | 15.32 | 4.1 | 206 | 13.9 |
| S | 0.995 | 4.41 | 292 | 14.63 | 4.3 | 277 | 12.91 | 4.1 | 278 | 12.57 |
| U | 0.996 | 4.45 | 307 | 10.96 | 4.2 | 304 | 9.84 | 4.06 | 294 | 11.06 |
| V | 0.996 | 4.49 | 294 | 14.87 | 4.44 | 282 | 15.4 | 4.11 | 284 | 13.79 |
| W | 0.996 | 4.48 | 286 | 11.61 | 5.07 | 285 | 12.71 | 4.24 | 276 | 7.74 |
| X | 0.997 | 4.4 | 295 | 13.24 | 4.35 | 283 | 11.08 | 4.34 | 270 | 10.57 |

| Flavorant | Week 3 | | | Week 4 | | | Week 5 | | |
|---|---|---|---|---|---|---|---|---|---|
| Formulation | pH | D90 nm | Turbidity | pH | D90 nm | Turbidity | pH | D90 nm | Turbidity |
| T | 3.74 | 241 | 7.04 | 3.6 | 291 | 7.75 | 3.6 | 289 | 7.48 |
| L | 4.07 | 200 | 3.04 | 4.01 | 205 | 3.09 | 3.92 | 193 | 3.32 |
| M | 3.83 | 238 | 5.68 | 3.69 | 282 | 6.18 | 3.67 | 298 | 6.39 |
| N | 4.08 | 202 | 5.49 | 3.93 | 226 | 6.47 | 3.86 | 226 | 5.02 |
| O | 4.46 | 274 | 13.85 | 4.01 | 276 | 16.96 | 3.86 | 252 | 16.31 |
| P | 4.14 | 227 | 9.63 | 3.41 | 208 | 17.88 | 3.61 | 265 | 13.95 |
| Q | 4.49 | 259 | 8.3 | 4.01 | 433 | 9.63 | 3.89 | 245 | 9.32 |
| R | 4.16 | 255 | 12.48 | 3.93 | 254 | 13.75 | 3.72 | 252 | 16.08 |
| S | 4.15 | 206 | 12.83 | 4.07 | 255 | 13.58 | 4.03 | 251 | 15.55 |
| U | 4.03 | 318 | 11.33 | 3.78 | 287 | 13.46 | 3.68 | 311 | 13.85 |
| V | 4.29 | 277 | 13.26 | 4.11 | 273 | 13.75 | 3.81 | 259 | 16.72 |
| W | 4.33 | 302 | 6.82 | 3.97 | 307 | 6.54 | 4.02 | 316 | 8.54 |
| X | 4.27 | 209 | 10.51 | 4.08 | 256 | 15.43 | 4.01 | 257 | 12.81 |

These results show that the emulsions are stable by using natural vitamins, providing a simple but effective alternative to other synthetic commonly used adjuvants. The results show that vitamin and vitamin salts can be efficiently used to emulsify the inventive emulsions, without the use of weighting agents and gum acacia. Further, the oil-in-water emulsions of the present technology exhibit a minimum fall in pH, turbidity, and particle size distribution over short and long term storage.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An oil-in-water emulsion composition comprises:
an oil phase comprising:
about 0.01 wt. % to about 30 wt. %, based on a total weight of the emulsion, of a flavorant; and
optionally about 0.01 wt. % to about 10 wt. % based on the total weight of the emulsion, of an emulsifier adjuvant; and
a continuous aqueous phase comprising:
about 0.01 wt. % to about 30 wt. %, based on the total weight of the emulsion, of a preservative comprising one or more vitamins and salts thereof;
about 0.01 wt. % to about 10 wt. %, based on the total weight of the emulsion, of an emulsifying agent; and
water.

2. The oil-in-water emulsion composition of claim 1, wherein the aqueous phase comprises about 0.01 wt. % to about 10 wt. %, based on the total weight of the emulsion, of a preservative comprising one or more vitamins and salts thereof.

3. The oil-in-water emulsion composition of claim 1, wherein the vitamin comprises vitamin C, vitamin E, and derivatives thereof.

4. The oil-in-water emulsion composition of claim 1, wherein the vitamin comprises ascorbic acid, α-tocopherol, β-tocopherol, γ-tocopherol, δ-tocopherol, ε-tocopherol, α-tocotrienol, β-tocotrienol, γ-tocotrienol, or δ-tocotrienol.

5. The oil-in-water emulsion composition of claim 1, wherein the vitamin salt comprises sodium ascorbate, calcium ascorbate, potassium ascorbate, ascorbyl palmitate, sodium ascorbyl phosphate, or magnesium ascorbyl phosphate.

6. The oil-in-water emulsion composition of claim 1, wherein the oil phase comprises about 0.01% to about 10% by weight, based on the total weight of the emulsion, of a flavorant.

7. The oil-in-water emulsion composition of claim 1, wherein the flavorant comprises a hop oil, a cannabis oil, a hemp oil, a hop extract, a flavorant blend, a hop-derived flavorant compounds, a non-hop derived flavorant compounds, or a combination of any two or more thereof.

8. The oil-in-water emulsion composition of claim 1, wherein the flavorant comprises a terpene or a blend of terpenes.

9. The oil-in-water emulsion composition of claim 1, wherein the emulsifying agent comprises a phospholipid, potassium sorbate, sorbitan monooleate, sorbitan monolaurate, sorbitan monopalmitate, sorbitan monostearate, sorbitan monostearate, xanthan gum, guar gum, carrageenan, locust bean gum, monoglycerides, diglycerides, ethoxylated castor oil, albumin, alginates, casein, egg yolk, glycerol monostearate, or a combination of any two or more thereof.

10. The oil-in-water emulsion composition of claim 1, wherein the emulsifying agent comprises a sunflower lecithin.

11. The oil-in-water emulsion composition of claim 1 comprising about 0.01% to about 5 wt. % emulsifying agent based on the total weight of the emulsion.

12. The oil-in-water emulsion composition of claim 1, wherein the emulsifier adjuvant comprises citric acid, malic acid, tartaric acid, ascorbic acid, caffeic acid, ferulic acid, or a salt thereof.

13. The oil-in-water emulsion composition of claim 1, comprising water in an amount corresponding to the balance of material in the oil-in-water emulsion composition.

14. The oil-in-water emulsion composition of claim 1, wherein the oil-in-water emulsion composition is substantially free of weighting agents and gum acacia.

15. An oil-in-water emulsion composition comprising:
about 0.01 wt. % to about 8 wt. %, based on a total weight of the emulsion, of one or more vitamins;
about 0.01 wt. % to about 8 wt. %, based on the total weight of the emulsion, of one or more vitamin salts;
about 0.5 wt. % to about 8 wt. %, based on the total weight of the emulsion, of one or more flavorants;
about 0.01 wt. % to about 5 wt. %, based on the total weight of the emulsion, of a sunflower lecithin; and
the balance being water.

16. The oil-in-water emulsion composition of claim 15, wherein the oil-in-water emulsion composition is substantially free of a weighting agent and gum acacia.

17. A product comprising the oil-in-water emulsion composition of claim 1, wherein the product is an edible product, a flavor product, or an aroma product.

18. The product of claim 17, wherein product is the edible product comprising a food or a beverage product.

19. The product of claim 18, wherein the beverage product is a fermented beverage; optionally wherein the fermented beverage comprises kombucha, beer, wine, or cider.

20. A method comprising:
providing an oil phase comprising a flavorant and optionally an emulsifier adjuvant;
providing an aqueous phase comprising water, a preservative comprising a vitamin, and a salt thereof, an emulsifying agent, and optionally an emulsifier adjuvant;
mixing the oil phase and the aqueous phase to obtain a pre-emulsion; and
homogenizing the pre-emulsion to obtain an oil-in-water emulsion;
optionally wherein the homogenizing comprises a multi-stage homogenization process.
